(19) United States
(12) Patent Application Publication
(10) Pub. No.: US 2026/0049807 A1
(43) Pub. Date: Feb. 19, 2026

(54) DEVICE AND METHOD FOR MEASURING GIRTH OF A SUBJECT

(71) Applicant: LTI Mindtree Ltd, Mumbai (IN)

(72) Inventors: Rex Jesudas P, Mumbai (IN); Swapnil Chavare, Mumbai (IN); Raviteja Doddi, Mumbai (IN)

(21) Appl. No.: 19/263,640

(22) Filed: Jul. 9, 2025

(30) Foreign Application Priority Data
Aug. 19, 2024 (IN) 202421062494

(51) Int. Cl. G01B 5/00; G01B 7/30

(52) U.S. Cl. CPC G01B 5/0035; G01B 7/30; G01B 2210/58

(57) ABSTRACT

The present disclosure relates to a device for measuring the girth of a subject. The device contains a retractable arm with a proximal (P) end and a distal (D) end. The distal (D) end of the retractable arm is pivotally connected to a spring enabling angle adjustments. A frame with a proximal (P) end and a distal (D) end connected to the spring at its proximal (P) end, the frame is configured with two arms with a fixed right-angled structure. The spring is adapted to exert force on the frame resulting in applying pressure on the retractable arm to maintain firm attachment of the device to the subject. A magnetic rotary encoder is associated with the spring to detect angle of deflections of the retractable arm, wherein the angle of deflection changes proportionally with changes in the girth of the subject.

### FIELD

Various embodiments of the present disclosure generally relate to a device for girth measurement. More specifically, the disclosure relates to a method and device for measuring the girth of a subject in real-time.

### BACKGROUND

Existing devices for measuring the girth of a subject rely primarily on manual measurements or expensive devices such as potentiometers. These methods necessitate continual expenditure on maintenance for various electronic components and power backups.

Potentiometer-based measurement systems frequently encounter issues with increased noise levels and the need for frequent recalibration. These challenges undermine the reliability and stability of the measurements, impacting the overall effectiveness and efficiency of girth measurement systems.

Additionally, the high cost of potentiometer-based methods includes the need for regular maintenance to ensure proper functionality over time. Typically, these methods involve manually measuring the girth of a subset of subjects, for example, 100 out of 100,000, and then approximating the measurements for the remaining subjects. This approach is both labor-intensive and time-consuming.

Other currently available devices employ various components and methods to measure a subject's girth. For example, some devices use collapsible tape. However, the non-sturdy nature of such tape often leads to inaccurate girth readings. Additionally, the tape material is prone to tearing due to wear and tear from different environmental conditions.

In certain scenarios, devices used for measuring the girth of trees employ a communication device known as a radio frequency identification (RFID) tag. This tag, affixed to individual trees, records important details such as ID, planting date, species, and other relevant information. A reader linked to the RFID tag identifies the tree's species and planting date to manage data related to its growth. While the RFID tag can provide data on disease history, location, lifespan, and growth distribution, it does not capture information about the tree's girth as it grows. Therefore, measuring the tree's girth according to its growth requires separate manual intervention.

Additionally, existing solutions include heavy machines integrated with equipment for measuring the girth of a subject. These machines, designed to integrate precise girth measurement equipment, often encounter issues related to accuracy, usability, and operational efficiency.

Therefore, there is a critical need for improvement in the mechanism used to measure the girth of a subject with enhanced accuracy and reliability. This need includes mitigating traditional and labor-intensive measurements that are prone to inaccuracies and misinterpretations, thereby improving overall operational performance and user satisfaction.

### SUMMARY

The present disclosure discloses a device and method for measuring the girth of a subject. The device comprises a retractable arm having a proximal end and a distal end. The distal end of the retractable arm is pivotally connected to the spring enabling angle adjustment. The device also comprises a frame with two arms that are fixed at a right angle structure.

The spring of the device is connected to a proximal end of the frame along a longitudinal axis. The spring facilitates the frame to hold firmly around the subject and causes the two arms fixed at right angles to deflect in angle with changes in the girth of the subject. The spring is adapted to exert force on the frame, thereby applying force on the retractable arm to maintain firm attachment to the subject by static friction.

A magnetic rotary encoder associated with the spring detects angle of deflections occurring in the retractable arm due to the change in angle in the two arms of the frame. The angle of deflection changes proportionally with changes in the girth of the subject. The magnetic rotary encoder transmits data related to the angle of deflection to a IoT gateway for further processing and actions.

One or more advantages of the prior art are overcome, and additional advantages are provided through the disclosure. Additional features are realized through the technique of the disclosure. Other embodiments and aspects of the disclosure are described in detail herein and are considered a part of the disclosure.

### BRIEF DESCRIPTION OF THE FIGURES

FIG. 1 is a diagram that illustrates an exemplary environment 100 within various embodiments of the disclosure may function.

FIG. 2 is a diagram that illustrates a girth measurement device 102 for measuring girth of a subject, in accordance with an embodiment of the disclosure

FIG. 3 is an exemplary diagram 300 that illustrates the girth measurement device 102 mounted on a cylindrical subject for measuring the girth, in accordance with an embodiment of the disclosure.

FIG. 4 is a diagram that illustrates a flow diagram 400 for a method for measuring the girth of a subject, in accordance with an embodiment of the disclosure.

### DETAILED DESCRIPTION

Various embodiments of the present disclosure relate to a device and method for measuring the girth of a subject. The device comprises a retractable arm having a proximal end and a distal end. The distal end of the retractable arm is pivotally connected to the spring enabling angle adjustment. The device also comprises a frame with two arms that are fixed at a right angle structure. The spring of the device is connected to a proximal end of the frame along a longitudinal axis. The spring facilitates the frame to hold firmly around the subject and causes the two arms fixed at right angles to deflect in angle with changes in the girth of the subject. The spring is adapted to exert force on the frame, thereby applying stress on the retractable arm to maintain firm attachment to the subject by static friction. The spring is adapted to exert force on the frame, thereby applying force on the retractable arm to maintain firm attachment to the subject by static friction.

A magnetic rotary encoder associated with the spring detects angle of deflections occurring in the retractable arm due to the change in angle in the frame. The detected angle of deflection changes proportionally with changes in the girth of the subject. The magnetic rotary encoder transmits data related to the angle of deflection to a IoT gateway for further processing.

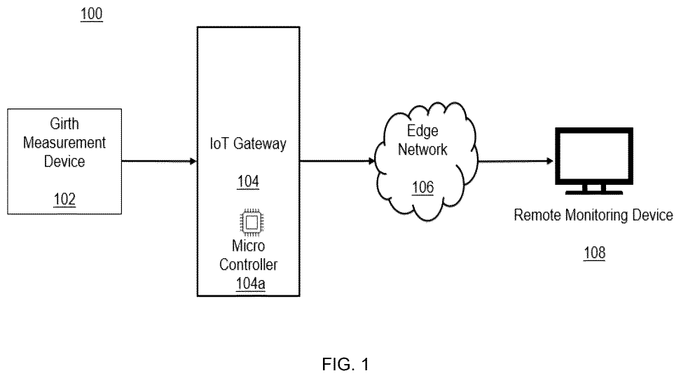

FIG. 1 is a diagram that illustrates an exemplary environment 100 within various embodiments of the disclosure may function. Referring to FIG. 1, the environment 100 comprises a girth measurement device 102, an IoT gateway 104, a microcontroller 104a, an edge network 106, and a remote monitoring device 108.

In one or more embodiments, the girth measurement device 102 is configured to measure girth or circumference of the subject using fundamental mechanical principles.

The measurements, such as angle of deflections, from the girth measurement device 102 are transmitted to the IoT gateway 104 for further processing. The angle of deflections refers to the deviation or angular displacement observed during the measurement process. These angles are important for assessing the precision of the measurement and for determining any irregularities or variations in the girth of the subject.

In one or more embodiment, the IoT gateway 104 acts as a central hub that collects data from various connected devices within the local network. The IoT gateway 104 is configured with necessary hardware and software to receive, store, and process the measurements received from the girth measurement device 102.

In one or more embodiments, the IoT gateway 104 further comprises the microcontroller 104a, which converts the angle of deflection data obtained from the girth measurement device 102 into a precise and proportional measurement of the subject's girth. The microcontroller 104a is programmed with algorithms and mathematical models to interpret the data received from the girth measurement device 102.

In some non-limiting embodiments, the microcontroller 104a processes the angle of deflection data, representing the angular displacement or deviation observed during the girth measurement. By using these deflection angles, the microcontroller 104a applies a series of calculations to convert this angular data into a linear measurement of girth. This conversion involves translating the angular measurements into a proportional linear value that accurately represents the subject's girth. For example, the result of this conversion process is a measurement expressed in millimeters, a standard unit of length that provides a precise and easily interpretable value for the subject's girth. This unit of measurement is crucial for ensuring clarity and consistency in reporting and utilizing the measurement data.

In some non-limiting embodiments, the results of the conversion at the microcontroller 104a are sent to the remote monitoring device 108 for review and further user actions, via the edge network 106. The edge network 106 is a decentralized computing framework that facilitates data processing closer to the IoT gateway 104.

The edge network 106 ensures that the converted results do not need to travel all the way to a central server or cloud service before it can be accessed or acted upon. Instead, the edge network 106 facilitates quicker and more direct communication between the microcontroller 104a and the remote monitoring device 108.

The remote monitoring device 108 is a system or application that receives and displays the data sent from the microcontroller 104a via the edge network 106. The remote monitoring device 108 can be, for example, a computer, tablet, smartphone, or specialized monitoring equipment located off-site or at a central control location.

In one or more embodiments, the remote monitoring device 108 allows users to review the information in real-time or as part of a data log. The review process involves evaluating the measurements, verifying their accuracy, and assessing any trends or patterns that might be relevant to the users' needs.

In an exemplary embodiment, based on the reviewed data, users can take further actions as required. These actions might include making decisions about subsequent steps in a process, adjusting parameters for future measurements, generating reports, or initiating alerts if the measurements indicate any anomalies or issues. The remote monitoring device 108 may provide tools for analyzing the data, visualizing it in charts or graphs, and integrating it with other systems or databases for comprehensive management.

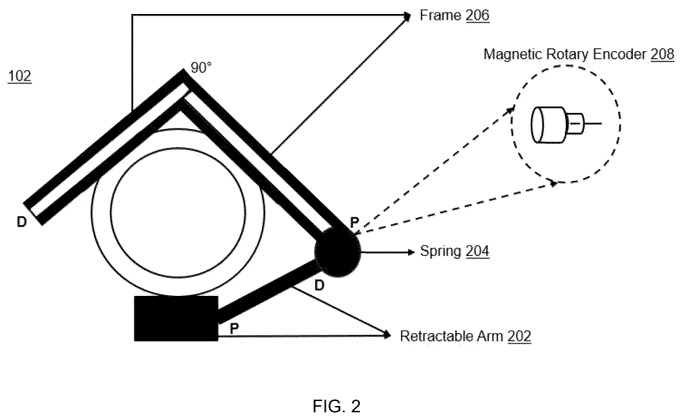

FIG. 2 is a diagram that illustrates the girth measurement device 102 for measuring girth of a subject, in accordance with an embodiment of the disclosure. Referring to FIG. 2, the girth measurement device 102 comprises a retractable arm 202, a spring 204, a frame 206, and a Magnetic Rotary Encoder 208.

In one or more embodiments, the retractable arm 202 comprises a proximal (P) end, which is closest to the central body of the girth measurement device 102, and a distal (D) end, which is furthest from the body of the girth measurement device 102. The distal (D) end of the retractable arm 202 is pivotally connected to the spring 204 using a pivot. This pivotal connection allows rotational movement of the retractable arm 202, enabling precise angle adjustments. The ability to adjust the angle between the retractable arm 202 and the spring 204 is crucial for adapting the device to different measurement scenarios or positions.

In one or more embodiments, the retractable arm 202 can extend outward and then retract back in. The retractable arm 202 ca be employed to encircle or position around the subject to take measurements. For instance, the retractable arm 202 can be adjusted to different lengths as needed for measurement. The retractable arm 202 is configured to fit various sizes or shapes of the subjects by extending or retracting.

In one or more embodiments, the frame 206, with a proximal (P) end and a distal (D) end, is connected to the spring 204 at the proximal (P) end. The connection occurs along a longitudinal axis that runs through the frame 206 at the proximal end (P). The longitudinal axis is essentially an imaginary line that runs from the proximal end (P) to the distal end (D) of the frame 206. The spring 204 exerts force on the frame 206, which is configured with two arms in a fixed right-angled structure. This configuration indicates that the two arms of the frame 206 are arranged in such a way that they meet at a 90-degree angle, creating a rigid and stable setup.

In some non-limiting embodiments, the girth measurement device 102 positions the two arms of the frame 206 at a precise angle of 90 degrees relative to each other. This initial configuration places the arms in a perpendicular arrangement, forming a right angle where they intersect. The first arm extends outward from the girth measurement device 102, while the second arm extends perpendicularly from the first arm, effectively creating an L-shaped setup. The right-angle positioning is crucial for ensuring accurate and consistent girth measurements, as it provides a standardized reference point for aligning with the subject.

In some non-limiting embodiments, the frame 206 is constructed from strong, lightweight materials that can withstand the mechanical stresses of operation while remaining easy to handle. The design of the frame 206 is optimized for easy adjustment and positioning of the two arms, allowing users to adapt the girth measurement device 102 to different measurement scenarios.

In one or more embodiments, the spring 204 is connected to the proximal (P) end of the frame 206 along its longitudinal axis. The spring 204 is attached to the proximal (P) end of the frame 206, which is the end closest to the main body of the girth measurement device 102. This alignment ensures that the force applied by the spring 204 is distributed evenly and effectively along the length of the frame 206.

The spring 204 exerts a consistent force that helps the frame 206 firmly engage with and conform to the shape of the subject being measured. As the frame 206 is positioned around the subject, whether it is a cylindrical object, a tree, or another type of subject, the spring 204 provides the necessary pressure to ensure that the frame 206 remains securely in place.

The spring 204 is configured to be responsive to changes in the girth of the subject. As the girth of the subject increases or decreases, the spring 204 adjusts accordingly. This dynamic adjustment causes the two arms of the frame 206 to deflect or move in response to these changes. When the girth expands, the spring 204 allows the frame 206 to accommodate this increase by causing the arms to extend or shift. Conversely, if the girth decreases, the spring 204 facilitates the retraction of the two arms of the frame 206 to maintain a proper fit around the subject.

The ability of the spring 204 to cause deflection in the two arms of the frame 206 is essential for ensuring that the girth measurement device 102 accurately reflects variations in girth. As the frame 206 adjusts to the subject's size, the deflection of the two arms allows the girth measurement device 102 to capture the true circumference or girth measurement without introducing errors due to misalignment or improper fitting.

In an exemplary embodiment, the spring 204 can be selected from a group consisting of a compression spring or a tension spring. The compression spring resists compressive forces, which means it is compressed when a load is applied. On the other hand, the tension spring is designed to resist stretching or pulling forces which allows it to stretch when a load is applied.

In one or more embodiments, the magnetic rotary encoder 208 is associated with the spring 204 of the girth measurement device 102. The magnetic rotary encoder 208 measures the angle of deflection of the retractable arm 202 due to changes in the angle of the frame 206. This angle of deflection is directly related to changes in the girth of the subject being measured.

In some non-limiting embodiments, as the girth of the subject changes, the angles at which the two arms of frame 206 are positioned also change correspondingly. The magnetic rotary encoder 208 continuously monitors these angular changes. By detecting the angle of deflection of the two arms of frame 206, the microcontroller 104a can accurately assess and record variations in the subject's girth. This proportional relationship allows the girth measurement device 102 to effectively capture and interpret dynamic changes in the subject's size or shape, ensuring accurate measurements and adjustments based on real-time data.

In some non-limiting embodiments, the microcontroller 104a may be powered using solar based approach and is facilitated with a battery backup. For instance, a 12V 60-watt solar panel is installed on site which is connected to a solar charge controller and further to battery. Both the controllers on site are being powered using this power source.

In an exemplary embodiment, the subject can be such as, but not limited to, a tree, a pipe, a cylindrical object, and a rock.

In accordance with the exemplary embodiment, the girth measurement device 102 is capable of measuring the girth of a tree trunk, which is crucial for applications in forestry, environmental studies, or landscaping. By adjusting the girth measurement device 102 to the appropriate size and position, the users can accurately determine the circumference of the tree, which is essential for assessing growth, health, and timber volume.

In accordance with the exemplary embodiment, the girth measurement device 102 is capable of measuring the girth of pipes, which is important in industries such as plumbing, construction, and manufacturing. Accurate girth measurements of pipes are essential for ensuring proper fit, installation, and alignment in various systems and structures.

In accordance with the exemplary embodiment, the girth measurement device 102 is capable of measuring girth of any cylindrical object, whether it is industrial equipment, storage tanks, or other rounded items. This versatility allows the device to be used in a wide range of applications where precise girth measurements of cylindrical shapes are required.

In accordance with the exemplary embodiment, the girth measurement device 102 is capable of measuring girth irregularly shaped rocks, which may be relevant in fields such as geology, mining, or landscaping. By adapting the girth measurement device 102 to the contours of the rock, users can obtain accurate measurements of its girth for various purposes, including geological surveys and natural resource management.

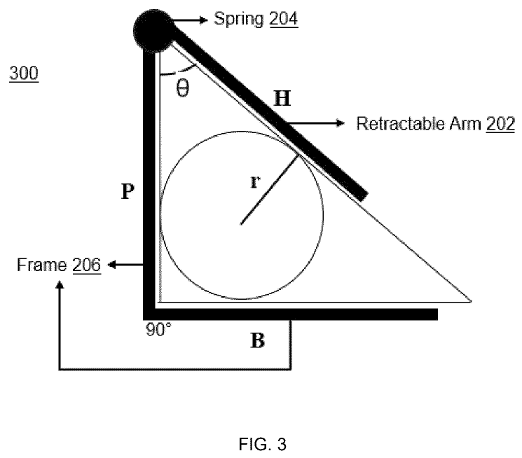

FIG. 3 is an exemplary diagram 300 that illustrates the girth measurement device 102 mounted on a cylindrical subject for measuring the girth, in accordance with an embodiment of the disclosure.

In one or more embodiments, the girth measurement device 102 with the two arms of the frame 206 is mounted on the cylindrical subject at right-angled triangle. The two arms of the frame 206 holds the cylindrical subject and constantly measures radius of incircle of the cylindrical subject by:

$$Radius = ( P + B - H ) / 2$$

Where, P & B are sides sharing the right angle and H is Hypotenuse.

As P is of fixed length,

$$\begin{matrix}B = P tan ( Θ ) \\ H = P sec ( Θ ) \\ r = ( P + P tan ( Θ ) - P sec ( Θ ) ) / 2\end{matrix}$$

Diameter of the Tree can be given by the following formula:

$$D = P * ( 1 + tan ( Θ ) - sec ( Θ ) )$$

Where P is the fixed length of the device between the arm hinge and the right angle.

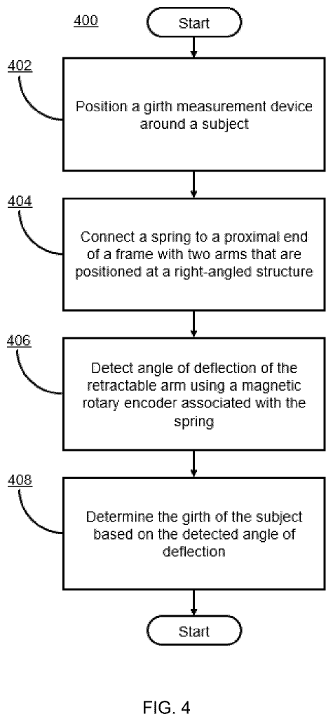

FIG. 4 is a diagram that illustrates a flow diagram 400 for a method for measuring the girth of a subject, in accordance with an embodiment of the disclosure.

At 402, the girth measurement device 102 comprising the retractable arm 202 is positioned around the subject. The retractable arm 202 is configured with a proximal (P) end, which is the end closest to the central body of the girth measurement device 102, and a distal (D) end, which is the end furthest from the body of the girth measurement device 102. The distal (D) end of the retractable arm 202 is designed to be pivotally connected to the spring 204.

In one or more embodiments, the retractable arm 202 can extend outward and then retract back in. The retractable arm 202 ca be employed to encircle or position around the subject to take measurements. For instance, the retractable arm 202 can be adjusted to different lengths as needed for measurement. The retractable arm 202 is configured to fit various sizes or shapes of the subjects by extending or retracting.

At 404, the spring 204 is connected to a proximal (P) end of the frame 206 with the two arms to exert force, causing the frame 206 to hold firmly around the subject and the two arms to deflect in response to changes in the girth of the subject.

The first arm of the two arms of the frame 206 extends outward from the girth measurement device 102, and the second arm extends perpendicularly from the first arm. The frame 206 is arranged in such a way that it spans across the two arms, bridging the gap between them and providing a stable structure for the measurement mechanism. The arrangement allows the frame 206 to align and support additional components or measurement tools mounted on the girth measurement device 102.

At 406, the angle of deflection of the retractable arm 202 is detected using the magnetic rotary encoder 208 associated with the spring 204. The magnetic rotary encoder 208 associated with the spring 204 detects angle of deflections occurring in the retractable arm 202 due to the change in angle in the frame 206. This angle of deflection is directly related to the changes in the girth of the subject being measured.

In an exemplary embodiment, the angle of deflection refers to the measure of how much the arm has shifted from its default right angled position. For instance, consider the two arms of the frame 206 are initially positioned at 90 degrees around a subject. If the girth of the subject increases, then the frame 206 with the two arms may bend or shift its angle from 90 degree to 120 degree, indicating that the frame 206 has deflected 30 degrees beyond the original position.

Conversely if the girth of the subject decreases, then the frame 206 with the two arms may bend or shift closer to the baseline, say for instance 60 degree, indicating that the frame 206 has deflected 30 degree less than the original position.

At 408, the girth of the subject is determined based on the detected angle of deflection. As the girth of the subject changes, the angles at which the two arms of the frame 206 are positioned also change correspondingly. The magnetic rotary encoder 208 continuously monitors these angular changes. By detecting the angle of deflection of the retractable arm 202, the microcontroller 104a can accurately assess and record variations in the subject's girth. This proportional relationship allows the girth measurement device 102 to effectively capture and interpret the dynamic changes in the subject's size or shape, ensuring accurate measurements and adjustments are made based on real-time data.

Advantageously, the girth measurement device relies on physical mechanisms, such as levers, gears, and retractable arms, instead of sophisticated electronic sensors and circuits. Electronic components, especially precision sensors and digital readout systems can be costly due to their advanced technology and manufacturing requirements.

The girth measurement device disclosed herein require fewer expensive materials and components compared to electronic devices, which allows manufacturers to manufacture them with standard materials and simpler processes, leading to lower overall production costs.

Additionally, the girth measurement device is also advantageous in that it usually consists of fewer components compared to electronic devices. For instance, retractable arms of the device might only involve basic parts like springs, gears, and levers. These mechanical components are generally simpler to repair or replace and often cost less than their electronic counterparts.

Moreover, the mechanical components of the girth measurement device are often more robust and durable in certain environments compared to electronic components, which can be sensitive to factors like humidity, temperature fluctuations, and dust. As a result, the present device can be less prone to breakdowns and may have a longer operational life, leading to fewer replacements and repairs.

Further, the operation of the girth measurement device is based on principles such as levers and gears. This simplicity in operation reduces the likelihood of operational errors and the need for complex troubleshooting.

Further, the design of the mechanical girth measurement device with retractable arms focuses on achieving accuracy and functionality through basic mechanical means. This reduced complexity not only makes the device affordable but also enhances reliability and ease of use.

Furthermore, the girth measurement device is designed and optimally engineered so as to provide real-time assistance to users in precisely calculating the Carbon Dioxide (CO₂) content at diverse geographical conditions, enabling continuous and precise monitoring of health of trees.

Those skilled in the art will realize that the above-recognized advantages and other advantages described herein are merely exemplary and are not meant to be a complete rendering of all of the advantages of the various embodiments of the present disclosure.

In the foregoing complete specification, specific embodiments of the present disclosure have been described. However, one of the ordinary skilled in the art appreciates that various modifications and changes can be made without departing from the scope of the present disclosure. Accordingly, the specification and figures are to be regarded in an illustrative rather than a restrictive sense. All such modifications are intended to be included within the scope of the present disclosure.

What is claimed is:

1. A girth measurement device comprising:
a retractable arm with a proximal (P) end and a distal (D) end;
a spring pivotally connected to the distal (D) end of the retractable arm enabling angle adjustment;
a frame with a proximal (P) end and a distal (D) end connected to the spring at a longitudinal axis at the proximal (P) end, wherein the spring exerts force on the frame that is configured with two arms with a fixed right-angled structure; and
a magnetic rotary encoder associated with the spring to detect angle of deflections of the retractable arm, wherein the angle of deflection changes proportionally with changes in the girth of a subject.

2. The girth measurement device as claimed in claim 1, wherein the frame, connected to the spring, is positioned on the subject with the two arms placed at right angles relative to each other.

3. The girth measurement device as claimed in claim 1, wherein the spring adapted to exert stress on the frame results in applying stress on the retractable arm to maintain firm attachment to the subject by static friction.

4. The girth measurement device as claimed in claim 1, the spring is selected from the group consisting of a compression spring and a tension spring.

5. The girth measurement device as claimed in claim 1, the magnetic rotary encoder transmits data related to the angle of deflection to a IoT gateway for further processing.

6. The girth measurement device as claimed in claim 5, wherein the IoT gateway comprises a microcontroller that converts the angle of deflection data into a proportional measurement of the girth of the subject in millimeters.

7. The girth measurement device as claimed in claim 1, wherein the subject is selected from the group consisting of a tree, a pipe, a cylindrical object, and a rock.

8. A method for measuring the girth of a subject, the method comprising:
positioning a girth measurement device having a retractable arm on the subject, wherein a distal (D) end of the retractable arm is pivotally connected to a spring to enable angle adjustment;
allowing the spring to exert stress on a frame configured with two arms fixed at a right-angled structure, causing the frame to hold firmly around the subject, wherein a proximal (P) end of the frame is connected to the spring;
detecting angle of deflections of the retractable arm using a magnetic rotary encoder associated with the spring, wherein the angle of deflection changes proportionally with changes in the girth of the subject; and
determining the girth of the subject based on the detected angle of deflection.

9. The method as claimed in claim 8, further comprising:
transmitting the data related to the angle of deflection from the magnetic rotary encoder to an IoT gateway for further processing.

10. The method as claimed in claim 9, further comprising:
converting, by a microcontroller in the IoT gateway, the angle of deflection data into a proportional measurement of the girth of the subject in millimeters.
